(19) United States
(12) Patent Application Publication
(10) Pub. No.: US 2009/0241703 A1
(43) Pub. Date: Oct. 1, 2009

(54) Retractable pen

(76) Inventor: Ming Huang, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 12/078,358

(22) Filed: Mar. 31, 2008

(51) Int. Cl. F16H 21/00

(52) U.S. Cl. 74/25

(57) ABSTRACT

A second sleeve (2) moved to and fro inside a cartridge (1) can be used to change a length of a retractable pen for writing. Because a first sleeve (5) fixed below the cartridge (1), a hood (6) fixed below and exposed outside the first sleeve (5), an inner sleeve (4) longer than the hood (6) further received inside the hood (6), and, at least, a positioning cleat (7) radially threaded through a longitudinal groove (22) of the second sleeve (2); when a second end (23) of the second sleeve (2) is pressed by or released from a pressure exerted by manual operation, which cause three-ring set of springs on circular grooves to stretch or retract a nib (31) for a writing or not, due to the cleat is operated in contact with a first or second dead center of the longitudinal groove respectively.

### FIELD OF THE INVENTION

The present invention is related to a retractable pen with a hood. moved to and fro, and an overall length of the pen is adjusted longer or shorter.

### BACKGROUND OF THE INVENTION

Although computer already becomes an efficient instrument devoted for dealing with text editor performance, but pen still a writing instrument required for signatures, making notices, . . . etc. To facilitate a retractable pen normally bringing in person can be used even for a magic performance, such as US published 20060264261 entitled “Electric spider pen” to Mesika, Yigal on Nov. 23, 2006 disclosed that invisible thread reel (ITR) should be prevented from knotting, snagging, catching, sticking, tangling or locking up of winding and unwinding a thread, which is precisely controlled as it feeds onto the spooler so that it is wound in an even and uniform manner, a molded plastic covering fitted over the spooler which has a small notch through which the thread can pass. The notch on this component can be rotated (in a complete circle) to change the orientation and direction of the thread during the spooling process.

However, the thread running through the rotated “notch” may chafe against each other once in a while. The small notch may obstruct the thread when rotated in alternated directions to tense up and relax the thread tension alternately.

Point against aforesaid problems, the present invention is to provide a retractable pen comprising:

A cartridge (1) is a hollowed tube with a first open end and a second open end;

A second sleeve (2) disposed within the cartridge (1) is axially moved inside the cartridge (1);

A hood (6) coupled to the first end of the second sleeve (2) is exposed outside the first sleeve (5), a brim circumference of the hood (6) is larger than an inscribed circle of the first sleeve (5);

A second end of the second sleeve (2) equipped with a plastic drum (21) is fit into the cartridge (1);

At least, a longitudinal groove (22) formed along the cartridge (1) tapered to a first dead center (22a) and a second dead center (22b);

An inner sleeve (4) fit into a second end of the hood (6) is longer than the hood (6); a second end of the inner sleeve (4) disposed above the hood (6);

A first sleeve (5) disposed within the first open end of the cartridge (1) fit over the second sleeve (2) accommodates the second sleeve (2) axially moved inside the cartridge (1) to resist against the plastic drum (21) so that the second sleeve (2) can be retained inside the cartridge (1); and

A refill (3) disposed within the second sleeve (2) is further received inside the inner sleeve (4), a second end of the refill (3) resists against a second end (23) of the inner sleeve (2);

A positioning cleat (7) radially led into the longitudinal groove (22), a second end of the positioning cleat (7) is fixed near the second end of the inner sleeve (4), a first end of the positioning cleat (7) is fixed to the first sleeve (5); the positioning cleat (7) moved downward inside the second sleeve (2) in contact with the first dead center (22a), the second sleeve (2) stops moving, a nib (31) is extended out for writing.

A retractable pen as claim 1 claimed wherein the positioning cleat (7) further can be moved upward inside the second sleeve (2) in contact with the second dead center (22b), the second sleeve (2) stops moving, a nib (31) is retracted into the cartridge.

A retractable pen as claim 1 claimed wherein the plastic drum (21) includes, a three-ring set of circular grooves (211) formed on a second end of the second sleeve (2), and a three-ring set of springs (212) fit over the circular grooves (211).

A retractable pen as claim 1 claimed wherein the longitudinal groove (22) is formed symmetrically on both left and right sides of the second sleeve (2) as two grooves opposed to each other at both left and right sides, the positioning cleat (7) also in one on one arrangement to the grooves (22) are provided as two cleats led into the longitudinal grooves (22) respectively.

A retractable pen as claim 1 claimed wherein the inner sleeve (4) and the first sleeve (5) are formed with holes (41, 51) respectively for receiving both ends of the positioning cleat (7).

A retractable pen as claim 1 claimed wherein notches (42, 52) formed on second ends of the inner sleeve (4) and the first sleeve (5) are corresponding to the holes (41, 51) of the longitudinal grooves (22) of the second sleeve (2).

A retractable pen as claim 1 claimed wherein the second end of the cartridge (1) sealed with a cap (11), a gas hole (12) formed through the cap (110), a second end of the second sleeve (2) has a hole (24) relative to a second end of the refill (3).

A retractable pen as claim 1 claimed wherein the hood (6) has outer threads (61) on a second end screwed to inner threads (25) of a first end of the second sleeve (2).

A retractable pen as claim 1 claimed wherein the first sleeve (5) fit in a hole formed through the first end of the cartridge (1), the second sleeve (2) fit in the first sleeve (5).

A retractable pen as claim 1 claimed wherein the first sleeve (5), the second sleeve (2), and the inner sleeve (4) are made from plastics.

### BRIEF DESCRIPTION OF DRAWINGS

FIG. 1: is an exploded view of the retractable pen of the present invention;

FIG. 2: is a perspective view of the retractable pen when shrunk;

FIG. 3: is a perspective view of the retractable pen when stretched; and

FIG. 4A˜4C: are diagrammatic views of the retractable pen in practice.

### DETAILED DESCRIPTION OF THE PREFERRED EMBODIMENTS OF THE PRESENT INVENTION

Description of the present invention is described in detail according to the appended drawings hereinafter.

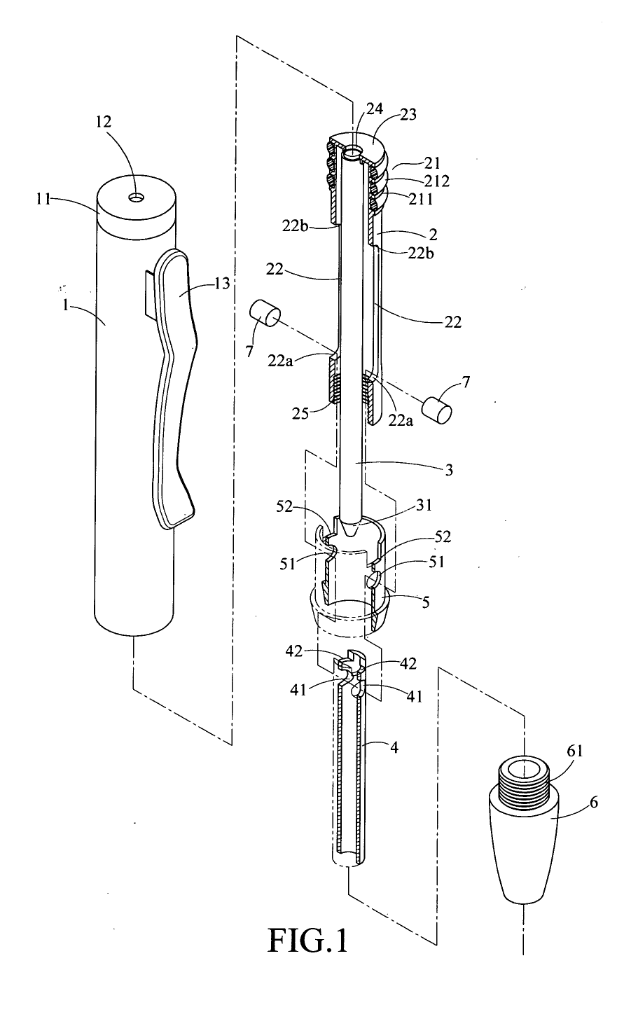

As shown in FIGS. 1˜3, the retractable pen includes a cartridge (1) is a hollowed tube with an open first end, and an open second end; a second sleeve (2) disposed inside the cartridge (1) can be axially moved to and fro inside the cartridge (1); a second end of the second sleeve (2) is further equipped with a plastic drum (21) fit into the cartridge (1) tightly, where a circumference of the plastic drum (21) circumvented by the cartridge (1) is not smaller than an inscribed circle or inner diameter of the cartridge (1); at least, a longitudinal groove (22) formed along a wall of the second sleeve (2); the groove (22) is tapered to form a second dead center (22b) and first dead center (22a). A first sleeve (5) fixed to the first open end of the cartridge (1) fits over the second sleeve (2) to accommodate the second sleeve (2) axially moved to and fro inside the cartridge and to prevent the plastic drum (21) from overstretching to expel the second sleeve (2) out of the cartridge (1). Thus the second sleeve (2) can be retained inside the cartridge (1). A hood (6) coupled to a first end of the second sleeve (2) is exposed outside the first sleeve (1). A brim circumference of the hood (6) is larger than an inscribed circle or inner diameter of the first sleeve (5). An inner sleeve (4), which is longer than the hood (6), has a first end fits in a second end of the hood (6); but a second end of the inner sleeve (4) normally is flushed with the second end of the hood (6). A refill (3) disposed inside the second sleeve (2) is further received inside the inner sleeve (4). At least, a positioning cleat (7) radially led in a longitudinal groove (22) of the second sleeve (2), a second end of the cleat (7) is coupled to the inner sleeve (4) near a second end of the inner sleeve (4), a first end of the cleat (7) is coupled to the first sleeve (5) about a central portion of the first sleeve (5). The positioning cleat (7) may selectively resist against a first dead center (22a) or a second dead center (22b) of the longitudinal groove (22), when the second sleeve (2) is axially moved to and fro, whereby the cleat (7) can stop moving the second sleeve (2) further upward or downward.

When assembling, first the cleat (7) is radially threaded in the longitudinal groove (22) of the second sleeve (2), and then the cleat (7) fit between the inner sleeve (4) and the first sleeve (5). Where the second end of the cleat (7) led into a hole (41) of the inner sleeve (4); the first end of the positioning cleat (7) led into a hole (51) of the first sleeve (5). Whereby, the second sleeve (2), the inner sleeve (4), and the first sleeve (5) are combined together integrally. Then the refill (3) received inside the inner sleeve (4) is coupled together with the hood (6), which is therefore coupled to and exposed outside the first end of the second sleeve (2). Finally, the first sleeve (5), after assemblage as above, is adhered inside the first open end of the cartridge (1) by adhesive, or by screwing. Thus the retractable pen is assembled.

Said inner sleeve (4) and the first sleeve (5) are assembled together by the cleat (7) fitted in between. As the inner sleeve (4) corresponded to the first sleeve (5), both of them further assembled together by the cleat (7) integrally as a whole with a stable configuration, further no stirring or any movements can be caused in between. Under such circumstances, the second sleeve (2), the refill (3), and the hood (6) coupled to and exposed outside the first end of the second sleeve (2) can be operated simultaneously. Such a simultaneous coordinated operation is caused by a manual operation from a user, such as the user operates the hood (6), where the second sleeve (2) connected to the hood (6) can be operated at the same time. The second sleeve (2) is operated moved between the first sleeve (5) and the inner sleeve (4). While the refill (3) is operated moved at the same time and impelled by the second sleeve (2).

As shown in diagrammatic views 4A˜4C, when a pressure is exerted to a second end (23) of the second sleeve (2), which is moved downward, till the positioning cleat (7) connected between the first sleeve (5) and the inner sleeve (4) is in contact with the first dead center (22a) of the longitudinal groove (22). When the second sleeve (2) stops moving downward, the second sleeve (2) is extended out of the cartridge (1). While the inner sleeve (4) can be retracted inside the hood (6), and a nib (31) of the refill (3) is extended out of the hood (6) for writing as shown in FIG. 3.

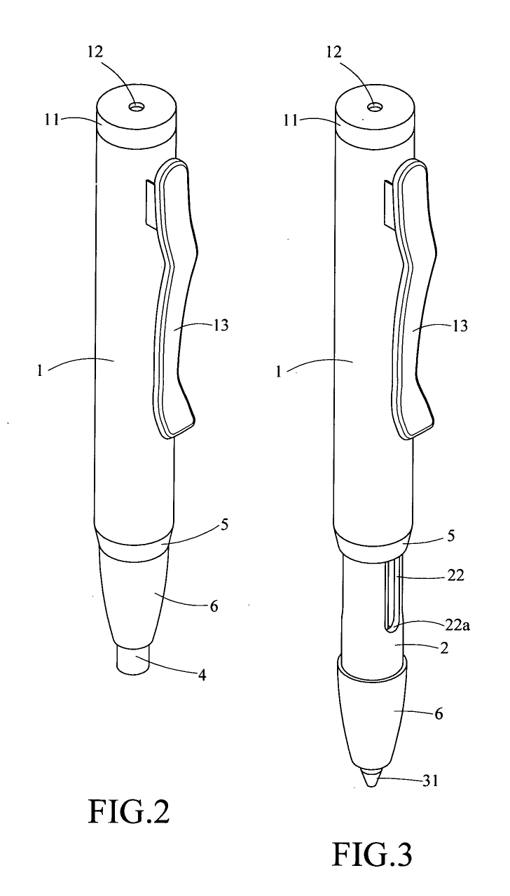

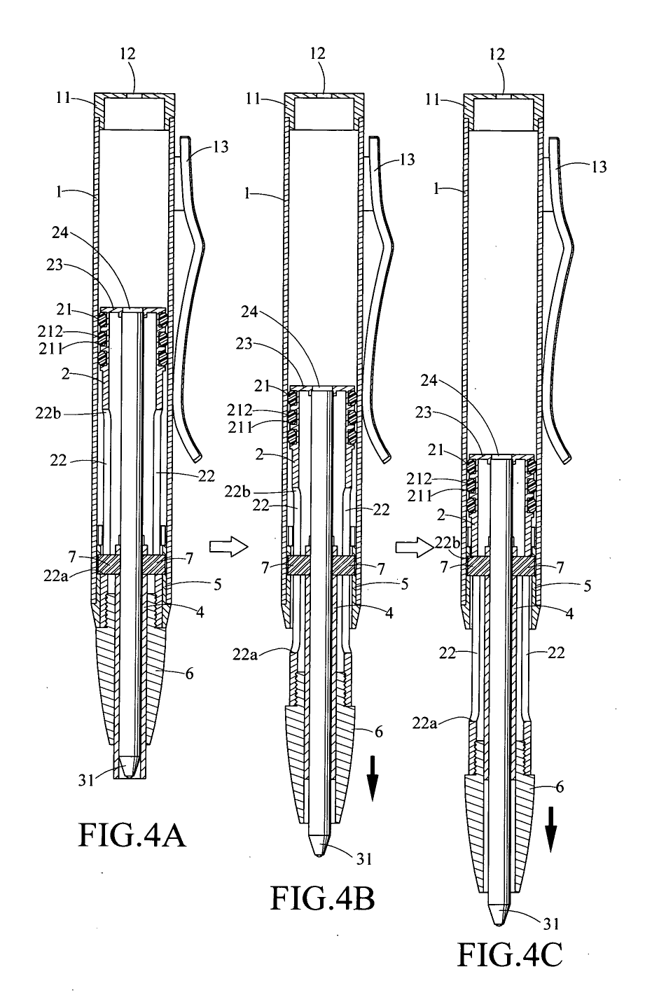

Conversely, as shown in FIGS. 4A˜4C, when the pressure is released from the second end (23) of the second sleeve (2), which is moved upward to be retracted inside the cartridge (1), till the positioning cleat (7) connected between the first sleeve (5) and the inner sleeve (4) is in contact with the second dead center (22b) of the longitudinal groove (22). When the second sleeve (2) stops moving upward, the inner sleeve (4) can cover up the nib (61) exposed below the hood (6). Therefore, the nib (31) is not able to write as shown in FIG. 2.

Said plastic drum (21) is composed of a three-ring set of circular grooves (211) formed on a second end of the second sleeve (2), and a three-ring set of springs (212) fit around the circular grooves (211). As shown in FIG. 4A, each of the circular grooves (211) and the springs (212) are shaped as three levels of grooves and springs. As a result, the three-ring set of springs (212) rub against the cartridge from inside can result in a friction resistance matched fair well. Although the second sleeve (2) adjusts between either stretching the nib for writing or retracting the nib, but the second sleeve (2) is not operated loosened from such reciprocal movements, and it will be operated smoothly overall.

The longitudinal groove (22) is preferably formed on both left and right sides of the second sleeve (2) in opposite to each other. Conversely, the cleat (7) is preferably led in both opposite grooves as above in one on one arrangement; therefore, the cleat (7) also can be replaced by a pair of cleats (7) instead, which lead in a pair of the opposite grooves (22) respectively.

Also as shown in FIG. 1, notches (42, 52) formed on second ends of the inner sleeve (4) and the first sleeve (5). The notch (42) is corresponding to and in alignment with the notch (52) even can be adjusted in position by a user manual operation based on easy naked eyesight. Thus the positioning cleat (7), which is connected between the inner sleeve (4) and the first sleeve (5), threaded through the longitudinal groove (22) can be led in the holes (41, 51) securely.

Moreover, a clip (13) disposed outside the cartridge (1), a second end of the cartridge sealed with a cap (11), a gas hole (12) formed through the cap (11). A hole (24) formed through the second end of the second sleeve (2), the hole (24) is corresponding to a second end of the refill (3), due to air circulated through the cartridge (1) by air convection; ink inside the refill (3) is easy to flow out from the nib for writing.

In addition, as shown in FIG. 1, the hood (6) with outer threads screwed in inner threads inside the first end of the second sleeve (2), thereby, when replacing a refill (3), only the hood (6) is detached from the cartridge (1), the refill (3) can be replaced promptly.

The first sleeve (5), the inner sleeve (4), and the second sleeve (2) made from plastics can be used to reduce friction resistance when the second sleeve (2) is axially moving to and fro.

### ADVANTAGES OF EMBODIMENTS OF THE PRESENT INVENTION

The retractable pen of the present invention is easy to assemble, with simple configuration. In use, there has no “break down” happened to the pen. And, labor cost and material cost can be saved.

In addition, a second end of the second sleeve (2) is equipped with a plastic drum (21), by which a friction resistance matched fair well between an inner wall of the cartridge (1) and the second sleeve (2). Thereby, the second sleeve (2) moved to and fro caused not any loosened movements happened to the second sleeve (2). Thus the second sleeve (2) is operated by user's manual operation only, the second sleeve (2) could not be moved to and fro by some spontaneous movements thereof. The well matched friction resistance between the cartridge (1) and the second sleeve (2) is smaller than conventional retractable pens. The retractable pen is easy to operate.

Furthermore, when operating, only the hood (6) is manually operated, the second sleeve (2) and the refill (3) can be operated simultaneously.

Not only a length of the pen can be altered, but also the nib (31) extended out for writing or retracted, no other components may be interfered with.

What is claim claimed:

1. A retractable pen comprising:
a cartridge (1) is a hollowed tube with a first open end and a second open end;
a second sleeve (2) disposed within the cartridge (1) is axially moved inside the cartridge (1);
a hood (6) coupled to the first end of the second sleeve (2) is exposed outside the first sleeve (5), a brim circumference of the hood (6) is larger than an inscribed circle of the first sleeve (5);
a second end of the second sleeve (2) equipped with a plastic drum (21) is fit into the cartridge (1);
at least, a longitudinal groove (22) formed along the cartridge (1) tapered to a first dead center (22a) and a second dead center (22b);
an inner sleeve (4) fit into a second end of the hood (6) is longer than the hood (6); a second end of the inner sleeve (4) disposed above the hood (6);
a first sleeve (5) disposed within the first open end of the cartridge (1) fit over the second sleeve (2) accommodates the second sleeve (2) axially moved inside the cartridge (1) to resist against the plastic drum (21) so that the second sleeve (2) can be retained inside the cartridge (1); and
a refill (3) disposed within the second sleeve (2) is further received inside the inner sleeve (4), a second end of the refill (3) resists against a second end (23) of the inner sleeve (2);
wherein a positioning cleat (7) radially led into the longitudinal groove (22), a second end of the positioning cleat (7) is fixed near the second end of the inner sleeve (4), a first end of the positioning cleat (7) is fixed to the first sleeve (5); the positioning cleat (7) moved downward inside the second sleeve (2) in contact with the first dead center (22a), the second sleeve (2) stops moving, a nib (31) is extended out for writing.

2. A retractable pen as claim 1 claimed wherein the positioning cleat (7) further can be moved upward inside the second sleeve (2) in contact with the second dead center (22b), the second sleeve (2) stops moving, a nib (31) is retracted into the cartridge.

3. A retractable pen as claim 1 claimed wherein the plastic drum (21) includes, a three-ring set of circular grooves (211) formed on a second end of the second sleeve (2), and a three-ring set of springs (212) fit over the circular grooves (211).

4. A retractable pen as claim 1 claimed wherein the longitudinal groove (22) is formed symmetrically on both left and right sides of the second sleeve (2) as two grooves opposed to each other at both left and right sides, the positioning cleat (7) also in one on one arrangement to the grooves (22) are provided as two cleats led into the longitudinal grooves (22) respectively.

5. A retractable pen as claim 1 claimed wherein the inner sleeve (4) and the first sleeve (5) are formed with holes (41, 51) respectively for receiving both ends of the positioning cleat (7).

6. A retractable pen as claim 1 claimed wherein notches (42, 52) formed on second ends of the inner sleeve (4) and the first sleeve (5) are corresponding to the holes (41, 51) of the longitudinal grooves (22) of the second sleeve (2).

7. A retractable pen as claim 1 claimed wherein the second end of the cartridge (1) sealed with a cap (11), a gas hole (12) formed through the cap (110), a second end of the second sleeve (2) has a hole (24) relative to a second end of the refill (3).

8. A retractable pen as claim 1 claimed wherein the hood (6) has outer threads (61) on a second end screwed to inner threads (25) of a first end of the second sleeve (2).

9. A retractable pen as claim 1 claimed wherein the first sleeve (5) fit in a hole formed through the first end of the cartridge (1), the second sleeve (2) fit in the first sleeve (5).

10. A retractable pen as claim 1 claimed wherein the first sleeve (5), the second sleeve (2), the inner sleeve (4) are made from plastics.
